(19) United States
(12) Patent Application Publication
(10) Pub. No.: US 2005/0222844 A1
(43) Pub. Date: Oct. 6, 2005

(54) Method and apparatus for generating spatialized audio from non-three-dimensionally aware applications

(76) Inventors: Hideya Kawahara, Mountain View, CA (US); Deron D. Johnson, Newark, CA (US); Daniel J. Petersen, Morgan Hill, CA (US)

Correspondence Address: A. RICHARD PARK, REG. NO. 41241;PARK, VAUGHAN & FLEMING LLP, 2820 FIFTH STREET, DAVIS, CA, 95616, US

(21) Appl. No.: 10/817,382

(22) Filed: Apr. 1, 2004

(51) Int. Cl. G10L 13/08; G10L 21/00

(52) U.S. Cl. 704/260; 704/270

(57) ABSTRACT

One embodiment of the present invention provides a system that facilitates generating spatialized audio from non-three-dimensional aware applications. The system operates by intercepting parameters associated with audio use from an application. The system then obtains location information of a display window associated with the application within a three-dimensional display. Next, the system calculates an audio source location for the audio and positions the audio at the audio source location in a three-dimensional sound space, wherein the audio source location is associated with a location of the display window in the three-dimensional display.

### RELATED APPLICATION

The subject matter of this application is related to the subject matter in a co-pending non-provisional application by the same inventors as the instant application entitled, “Method and Apparatus for Implementing a Scene-Graph-Aware User Interface Manager,” having Ser. No. 10/764,065, and filing date 22 Jan. 2004, which is incorporated herein by reference (Attorney Docket No. SUN04-0617-EKL).

### BACKGROUND

1. Field of the Invention

The present invention relates to computer-generated audio. More specifically, the present invention relates to a method and an apparatus for generating spatialized audio from non-three-dimensionally aware computer applications.

2. Related Art

Today, most personal computers and other high-end devices support window-based graphical user interfaces (GUIs), which were originally developed back in the 1980's. These window-based interfaces allow a user to manipulate windows through a pointing device (such as a mouse), in much the same way that pages can be manipulated on a desktop. However, because of limitations on graphical processing power at the time windows were being developed, many of the design decisions for windows were made with computational efficiency in mind. In particular, window-based systems provide a very flat (two-dimensional) 2D user experience, and windows are typically manipulated using operations that keep modifications of display pixels to a minimum. Even today's desktop environments like Microsoft Windows (distributed by the Microsoft Corporation of Redmond, Wash.) include vestiges of design decisions made back then.

In recent years, because of increasing computational requirements of 3D applications, especially 3D games, the graphical processing power of personal computers and other high-end devices has increased dramatically. For example, a middle range PC graphics card, the “GeForce2 GTS” distributed by the NVIDIA Corporation of Santa Clara, Calif., provides a 3D rendering speed of 25 million polygons-per-second, and Microsoft's “Xbox” game console provides 125 million polygons-per-second. These numbers are significantly better than those of high-end graphics workstation in the early 1990's, which cost tens of thousands (and even hundreds of thousands) of dollars.

As graphical processing power has increased in recent years, a number of 3D user interfaces have been developed. These 3D interfaces typically allow a user to navigate through and manipulate 3D objects. These 3D user interfaces often represent their constituent 3D objects and the relationships between these 3D objects using a “scene graph.” A scene graph includes nodes and links that describe graphical components and relationships between them. For example, graphical components include graphical objects, such as boxes and images, or user interface components, such as buttons and check boxes. (Note that although this specification describes a scene graph that represents 3D graphical components in a 3D display, a scene graph can also be used to represent 2D graphical components in a 2D display.)

A scene graph defines properties for these graphical components, including color, transparency, location, transformations such as rotation and scaling, and sound. Note that these properties can be expressed in a special kind of node, or alternatively, can be embedded in a graphical node. A scene graph can also define groupings of graphical objects and spatial relationships between graphical objects.

A number of different representations can be used to specify scene graphs. For example, a scene graph can be specified using the Java3D scene graph standard, the Virtual Reality Modeling Language (VRML) standard, or the SVG (Scalable Vector Graphics) standard. A scene graph can also be specified using the extensible Markup Language (XML) format; it is even possible to express a simple scene graph using a HyperText Markup Language (HTML) document.

Graphical display systems typically operate through a window manager, which manages interactions between the user and client applications. In doing so, the window manager accepts user inputs, and translates them into corresponding actions for to the client applications. The window manager can then cause the corresponding actions to be performed, possibly based on predefined policies. A window manager can also accept requests from client applications, for example to perform actions on visual or audio representations, and can then perform corresponding actions based on some policies.

Modern 3D graphics systems include capabilities to position sound based upon, inter alia, the position of an object on a 3D graphics display. This allows a user to more easily recognize the source object of a sound by using the spatial audio cues provided by the sound system. These sound systems typically include a so-called 5.1 speaker system, which includes left front, right front, left rear, right rear, center channel and subwoofer speaker components.

Unfortunately, these 3D graphics and sound systems do not support positioning the apparent audio location for legacy 2D applications. Thus, a user does not receive spatial audio cues from these legacy applications.

Hence, what is needed is a method and an apparatus, which supports spatial audio positioning for legacy 2D applications.

### SUMMARY

One embodiment of the present invention provides a system that facilitates generating spatialized audio from non-three-dimensional aware applications. The system operates by intercepting parameters associated with audio use from an application. The system then obtains location information of a display window associated with the application within a three-dimensional display. Next, the system calculates an audio source location for the audio and positions the audio at the audio source location in a three-dimensional sound space, wherein the audio source location is associated with a location of the display window in the three-dimensional display.

In a variation of this embodiment, intercepting information about audio use involves intercepting an audio stream from the application.

In a further variation, intercepting information about audio use involves intercepting parameters associated with an audio stream from the application.

In a further variation, obtaining location information of the display window associated with the application involves determining a set of coordinates on the three-dimensional display where the display window is located.

In a further variation, calculating the audio source location involves using the location of the display window to calculate coordinates for the audio source location so that audio from the audio source location appears to originate at the location of the display window.

In a further variation, intercepting information about audio use involves inserting wrapper code around an audio application programming interface (API) to intercept calls to the audio API.

In a further variation, the audio API routes intercepted audio information to a three-dimensional window manager.

In a further variation, the three-dimensional window manager manipulates the audio information to position an apparent audio location prior to sending the audio information to code underlying the audio API.

In a further variation, the three-dimensional window manager reduces audio volume of other applications when a given application is issuing a request for a warning tone so that the warning tone from the given application is predominant.

In a further variation, when a given application is issuing a request for user attention or the three-dimensional window manager decides to get the user's attention to a certain application running in the three-dimensional window, the system applies spatial audio effects to the audio that the application is generating, wherein the spatial effects include panning the audio source location in the three-dimensional space left and right repeatedly and rapidly.

### BRIEF DESCRIPTION OF THE FIGURES

FIG. 1 illustrates a three-dimensional display space in accordance with an embodiment of the present invention.

FIG. 2 illustrates a real-world sound system in accordance with an embodiment of the present invention.

FIG. 3 illustrates a computer system in accordance with an embodiment of the present invention.

FIG. 4 presents a flowchart illustrating the process of in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Three-Dimensional Display Space

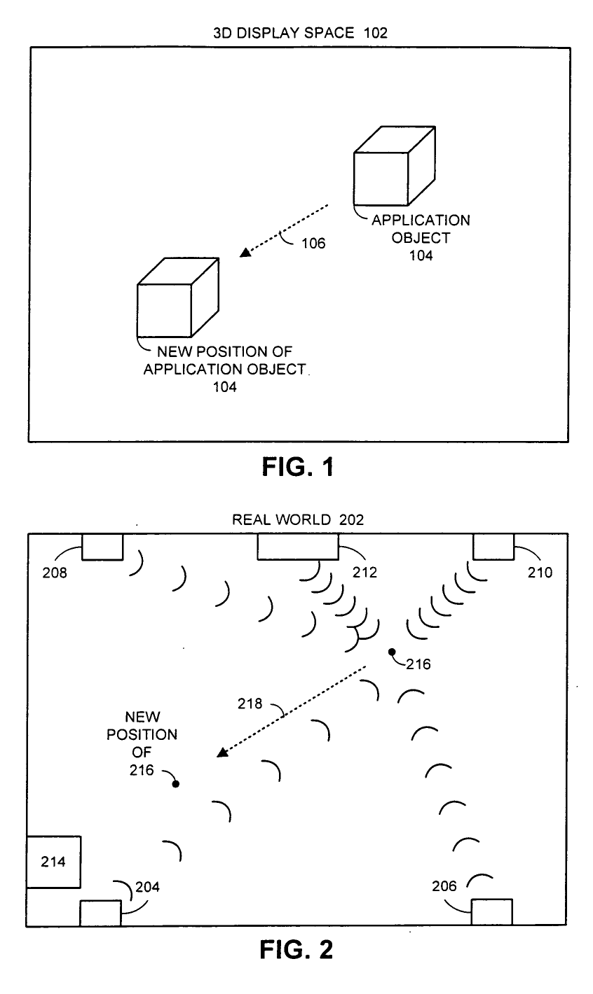

FIG. 1 illustrates a three-dimensional display space 102 in accordance with an embodiment of the present invention. Three-dimensional display space 102 includes an application object 104. During operation of the system, application object 104 can be moved along path 106 to a new position by an explicit command of a user or implicitly by a process being performed by application object 104. Details of displaying and moving application object 104 in display space 102 are included in the related U.S. patent application Ser. No. 10/764,065, which is herein incorporated by reference.

Sound System

FIG. 2 illustrates a real-world sound system 202 in accordance with an embodiment of the present invention. Real-world 202 includes a 5.1 speaker system with left front speaker 206, right front speaker 210, left rear speaker 204, right rear speaker 206, center channel speaker 212, and sub-woofer 214. Note that other types of speaker systems that produce spatial effects can be used with varying results. For example, a pair of stereo speakers can be used with much reduced spatial cueing.

The various speakers of the 5.1 speaker system can be driven so that the audio appears to emanate from, for example, audio focal point 216. Details of how this is accomplished are well-known in the art and will not be discussed further herein.

During operation of the system, when application object 104 is moved along path 106 to a new position, the signals supplied to the various speakers move the audio focal point 216 along path 218 to the new position of audio focal point 216. Moving audio focal point 216 in concert with moving application object 104 provides audio cues to the user when application object 104 provides sound to the user. Note that moving the spatial location of the sound as described herein is a three-dimensional operation which is difficult to represent in a two-dimensional drawing.

Computer System

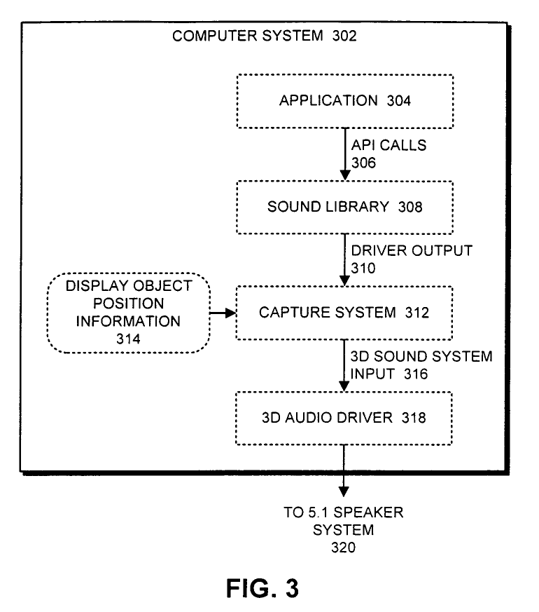

FIG. 3 illustrates computer system 302 in accordance with an embodiment of the present invention. Computer system 302 includes application 304, sound library 308, capture system 312, and three-dimensional audio driver 318. During operation, when application 304 generates a sound, application 304 makes an API call 306 to sound library 308.

Sound library 308 generates an audio output and supplies driver output 310 to capture system 312. Capture system 312 has been inserted in the flow to capture the audio output and to reposition the apparent sound location for the audio output.

Capture system 312 also receives display object position information 314 from the three-dimensional display system. Capture system 312 uses display object position information 314 to calculate an appropriate position for audio focal point 216 to give a user an audio cue as to which display object is generating the sound.

Capture system 312 then supplies three-dimensional sound system input 316 to three-dimensional audio driver 318. Three-dimensional audio driver 318 driver passes signals to the 5.1 speaker system 320 in a manner that provides the spatial reference for the generated sounds.

Positioning The sound

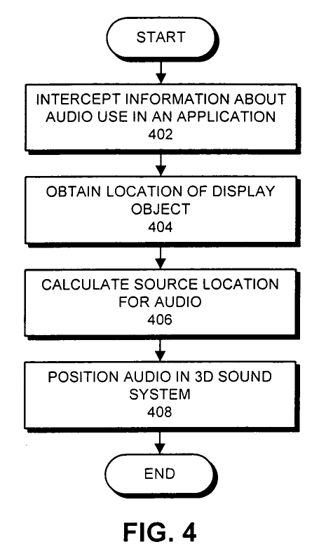

FIG. 4 presents a flowchart illustrating the process of positioning sound in accordance with an embodiment of the present invention. The system starts by intercepting information about audio use from an application (step 402). This information can include an audio stream or information about an audio stream. Note that this capture is accomplished by reconfiguring the application execution environment so that an application uses wrapper code rather than directly accessing the audio API. The wrapper code is bound to the application when the application starts. When the application creates sound, the wrapper code intercepts the call and routes it to the 3D audio code.

Next, the system obtains the location of a display object associated with the audio information (step 404). The location of the display object is found by sending the information about the audio use to the 3D window manager. The 3D window manager and the application typically execute in different processes and communication is through interprocess communication.

The system then calculates an apparent source location for the audio based upon the location of the display object (step 406). This apparent source location is calculated by the 3D window manager so that the sound is positioned in 3D space based on the position of the visual representation of the application. By moving the apparent source location of the audio, the system provides audio cues to a user concerning which application is providing the sound. Finally, the system positions the apparent audio source using the three-dimensional sound system based on the above calculations (step 408).

Additional Features

In one embodiment of the present invention, the 3D window manager can change the volume of an application's audio based upon the application's status. For example, when the application gets the user focus, the window manager can make its volume higher, and when it loses user input focus, the window manager can make its volume lower.

In one embodiment of the present invention, the 3D window manager can change the volume of the application's audio based on the application's visual translucency. If the application's visual representation becomes more translucent, the system can reduce the volume of the audio associated with the application.

In one embodiment of the present invention, the 3D window manager can make unusual effects on the application's audio when the application needs to capture the user's attention. For example, when the application issues a warning tone, the 3D window manager can swing the apparent location of the application's audio source rapidly several times to the right and left.

In one embodiment of the present invention, when one application issues a warning tone, the 3D window manager lowers the volume of all other application's audio to make the audio from the application needing attention is predominant.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is

1. A method for generating spatialized audio from non-three-dimensionally aware applications, comprising:
intercepting parameters associated with audio use from an application;
obtaining location information of a display window associated with the application within a three-dimensional display;
calculating an audio source location for the audio; and
positioning the audio at the audio source location in a three-dimensional sound space, wherein the audio source location is associated with a location of the display window in the three-dimensional display.

2. The method of claim 1, wherein intercepting information about audio use involves intercepting an audio stream from the application.

3. The method of claim 1, wherein intercepting information about audio use involves intercepting parameters associated with an audio stream from the application.

4. The method of claim 1, wherein obtaining location information of the display window associated with the application involves determining a set of coordinates on the three-dimensional display where the display window is located.

5. The method of claim 1, wherein calculating the audio source location involves using the location of the display window to calculate coordinates for the audio source location so that audio from the audio source location appears to originate at the location of the display window.

6. The method of claim 1, wherein intercepting information about audio use involves inserting wrapper code around an audio application programming interface (API) to intercept calls to the audio API.

7. The method of claim 6, wherein the audio API routes intercepted audio information to a three-dimensional window manager.

8. The method of claim 7, wherein the three-dimensional window manager manipulates the audio information to position an apparent audio location prior to sending the audio information to code underlying the audio API.

9. The method of claim 1, further comprising reducing audio volume of other applications when a given application is issuing a request for a warning tone, wherein reducing audio volume of other applications causes the warning tone from the given application to be predominant.

10. The method of claim 1, wherein when a given application is issuing a request for user attention or the three-dimensional window manager decides to get the user's attention to a certain application running in the three-dimensional window, the method further comprises applying spatial audio effects to the audio that the application is generating, wherein the spatial effects include panning the audio source location in the three-dimensional space left and right repeatedly and rapidly.

11. A computer-readable storage medium storing instructions that when executed by a computer cause the computer to perform a method for generating spatialized audio from non-three-dimensionally aware applications, the method comprising:
intercepting information about audio use from an application;
obtaining location information of a display window associated with the application within a three-dimensional display;
calculating an audio source location for the audio; and
positioning the audio at the audio source location in a three-dimensional sound space, wherein the audio source location is associated with a location of the display window in the three-dimensional display.

12. The computer-readable storage medium of claim 11, wherein intercepting information about audio use involves intercepting an audio stream from the application.

13. The computer-readable storage medium of claim 11, wherein intercepting parameters associated with audio use involves intercepting information about an audio stream from the application.

14. The computer-readable storage medium of claim 11, wherein obtaining location information of the display window associated with the application involves determining a set of coordinates on the three-dimensional display where the display window is located.

15. The computer-readable storage medium of claim 11, wherein calculating the audio source location involves using the location of the display window to calculate coordinates for the audio source location so that audio from the audio source location appears to originate at the location of the display window.

16. The computer-readable storage medium of claim 11, wherein intercepting information about audio use involves inserting wrapper code around an audio application programming interface (API) to intercept calls to the audio API.

17. The computer-readable storage medium of claim 16, wherein the audio API routes intercepted audio information to a three-dimensional window manager.

18. The computer-readable storage medium of claim 17, wherein the three-dimensional window manager manipulates the audio information to position an apparent audio location prior to sending the audio information to code underlying the audio API.

19. The computer-readable storage medium of claim 11, the method further comprising reducing audio volume of other applications when a given application is issuing a request for a warning tone, wherein reducing audio volume of other applications causes the warning tone from the given application to be predominant.

20. The computer-readable storage medium of claim 11, wherein when a given application is issuing a request for user attention or the three-dimensional window manager decides to get the user's attention to a certain application running in the three-dimensional window, the method further comprises applying spatial audio effects to the audio that the application is generating, wherein the spatial effects include panning the audio source location in the three-dimensional space left and right repeatedly and rapidly.

21. An apparatus, for generating spatialized audio from non-three-dimensionally aware applications, comprising:
an intercepting mechanism configured to intercept parameters associated with audio use from an application;
a location obtaining mechanism configured to obtain location information of a display window associated with the application within a three-dimensional display;
a calculating mechanism configured to calculate an audio source location for the audio; and
a positioning mechanism configured to position the audio at the audio source location in a three-dimensional sound space, wherein the audio source location is associated with a location of the display window in the three-dimensional display.

22. The apparatus of claim 21, wherein intercepting information about audio use involves intercepting an audio stream from the application.

23. The apparatus of claim 21, wherein intercepting information about audio use involves intercepting parameters associated with an audio stream from the application.

24. The apparatus of claim 21, wherein obtaining location information of the display window associated with the application involves determining a set of coordinates on the three-dimensional display where the display window is located.

25. The apparatus of claim 21, wherein calculating the audio source location involves using the location of the display window to calculate coordinates for the audio source location so that audio from the audio source location appears to originate at the location of the display window.

26. The apparatus of claim 21, wherein intercepting information about audio use involves inserting wrapper code around an audio application programming interface (API) to intercept calls to the audio API.

27. The apparatus of claim 26, wherein the audio API routes intercepted audio information to a three-dimensional window manager.

28. The apparatus of claim 27, wherein the three-dimensional window manager manipulates the audio information to position an apparent audio location prior to sending the audio information to code underlying the audio API.

29. The apparatus of claim 21, further comprising an volume reducing mechanism configured to reduce the audio volume of other applications when a given application is issuing a request for a warning tone, wherein reducing audio volume of other applications causes the warning tone from the given application to be predominant.

30. The apparatus of claim 21, wherein the positioning mechanism is further configured to apply spatial audio effects to the audio that the application is generating when a given application is issuing a request for user attention or the three-dimensional window manager decides to get the user's attention to a certain application running in the three-dimensional window, wherein the spatial effects include panning the audio source location in the three-dimensional space left and right repeatedly and rapidly.
